(19) United States
(12) Patent Application Publication
(10) Pub. No.: US 2026/0137032 A1
(43) Pub. Date: May 21, 2026

(54) DRIVE MOTOR MOUNTING ON ELECTRIFIED CHORE PRODUCT

(71) Applicant: Briggs & Stratton, LLC, Wauwatosa, WI (US)

(72) Inventor: Steven Joehnk, Waukesha, WI (US)

(21) Appl. No.: 19/119,583

(22) PCT Filed: Oct. 13, 2023
(86) PCT No.: PCT/US2023/035098

§ 371 Date: Apr. 9, 2025

Related U.S. Application Data
(60) Provisional application No. 63/415,865, filed on Oct. 13, 2022.

(51) Int. Cl. A01D 69/02; A01D 34/64; A01D 67/00; A01D 101/00; B62D 11/04

(52) U.S. Cl. CPC A01D 69/02; A01D 67/00; A01D 34/64; A01D 2101/00; B62D 11/04

(57) ABSTRACT

A chore product includes a chassis, an energy storage device supported by the chassis, a left drive assembly, and a right drive assembly. Each of the left drive assembly and the right drive assembly includes a drive motor coupled to the energy storage device, an axle coupled to a left tractive element or a right tractive element, and a transmission positioned between the drive motor and the axle. The transmission includes a housing having a first end and a second end. The housing defines a first interface positioned at the first end and engaging with the drive motor, a second interface positioned at the second end and receiving the axle, a third interface positioned proximate the second end and extending from the housing in a first direction, and a fourth interface positioned proximate the second end and extending from the housing in a second direction generally opposite the first direction.

### CROSS-REFERENCE TO RELATED PATENT APPLICATION

This application claims the benefit and priority to U.S. Provisional Patent Application No. 63/415,865, filed Oct. 13, 2022, which is incorporated herein by reference in its entirety.

### BACKGROUND

Current trends for outdoor power equipment, including lawn mowers, include adding electrification (e.g., batteries, battery packs, electric motors, blade motors, drive/tractive motors, etc.) to replace or supplement the power that has traditionally been provided by an internal combustion engine.

### SUMMARY

One embodiment relates to an electrified chore product. The electrified chore product includes a chassis, an energy storage device supported by the chassis, a left tractive element, a right tractive element, a left drive assembly coupled to the chassis, and a right drive assembly coupled to the chassis. Each of the left drive assembly and the right drive assembly includes a drive motor coupled to the energy storage device, an axle coupled to a respective one of the left tractive element or the right tractive element, and a transmission positioned between the drive motor and the axle. The transmission includes a housing having a first end and a second end. The housing defines a first interface positioned at the first end and engaging with the drive motor, a second interface positioned at the second end and receiving the axle, a third interface positioned proximate the second end and extending from the housing in a first direction, and a fourth interface positioned proximate the second end and extending from the housing in a second direction generally opposite the first direction. The left drive assembly and the right drive assembly are mountable to the chassis in either (a) a first orientation where the third interface of the left drive assembly and the fourth interface of the right drive assembly align or (b) a second orientation where the third interface of the left drive assembly and the third interface of the right drive assembly align.

Another embodiment relates to a driveline for an electrified chore product. The driveline includes a first drive assembly, a second drive assembly, and a cross-brace extending between the first drive assembly and the second drive assembly. Each of the first drive assembly and the second drive assembly includes a drive motor, an axle configured to couple to a tractive element, and a transmission including a housing having (a) a first end coupled to the drive motor and (b) a second end longitudinally offset from the first end and coupled to the axle. The first drive assembly and the second drive assembly are mountable to frames of the electrified chore products in different orientations to provide varying width wheel tracks.

Still another embodiment relates to a driveline for an electrified chore product. The driveline includes a first drive assembly configured to couple to a first lateral side of a chassis of the electrified chore product and a second drive assembly configured to couple a second lateral side of the chassis. Each of the first drive assembly and the second drive assembly includes a drive motor, an axle configured to couple to a tractive element, and a transmission including a housing having (a) a first end coupled to the drive motor and (b) a second end longitudinally offset from the first end and coupled to the axle. The first drive assembly and the second drive assembly are configured to be arranged in a plurality of orientations including (a) a first orientation where the drive motor of the first drive assembly and the drive motor of the second drive assembly are longitudinally aligned along a longitudinal axis of the chassis and (b) a second orientation where the drive motor of the first drive assembly and the drive motor of the second drive assembly are at least partially laterally overlapping.

Yet another embodiment a driveline for an electrified chore product. The driveline includes a drive assembly configured to couple to a lateral side of a chassis of the electrified chore product. The drive assembly includes a drive motor, an axle configured to couple to a tractive element where the axle defines a lateral axis, and a transmission including a housing having (a) a first end coupled to the drive motor and (b) a second end longitudinally offset from the first end and coupled to the axle. The drive assembly is configured to be arranged in a plurality of orientations including a first orientation where the drive motor is positioned at least partially forward of the lateral axis and a second orientation where the drive motor is positioned at least partially rearward of the lateral axis.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a chore product, according to an exemplary embodiment.

FIG. 2 is a perspective view of a chore product, according to another exemplary embodiment.

FIG. 3 is a schematic diagram of the chore product of FIG. 1 and FIG. 2, according to an exemplary embodiment.

FIG. 4 is a perspective view of a driveline of the chore product of FIG. 1 and/or FIG. 2 in a first orientation, according to an exemplary embodiment.

FIG. 5 is a bottom view of the driveline of FIG. 4, according to an exemplary embodiment.

FIG. 6 is a side view of the driveline of FIG. 4, according to an exemplary embodiment.

FIG. 7 is a perspective view of the driveline of the chore product of FIG. 1 and/or FIG. 2 in a second orientation, according to an exemplary embodiment.

FIG. 8 is a bottom view of the driveline of FIG. 7, according to an exemplary embodiment.

FIG. 9 is a side view of the driveline of FIG. 7, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

In general, lawn mowers utilize a prime mover to drive one or more cutting blades to cut material (e.g., grass), as well as to drive tractive elements of the lawn mower to move the lawn mower along a travel path. Traditionally, the prime mover is an internal combustion engine. The lawn mower of the present disclosure replaces the traditional internal combustion engine with independent motors to drive the cutting blades and the tractive elements. According to an exemplary embodiment, a driveline of the lawn mower includes independent tractive motors for each of the driven tractive elements. Such independent tractive motors can be arranged in multiple orientations to provide varying width wheel tracks to support different styles or types of lawn mowers that require different width wheel tracks, without requiring replacing drive components (e.g., motors, transmissions, axles, etc.) of the driveline.

A “chore product” as used herein refers to any type of equipment, machine, or vehicle that may be used to perform a chore (e.g., an outdoor chore, an indoor chore, lawn care, etc.). For example, a chore product may include a motor, a pump, an actuator, a compressor, and/or another device that is electrically-powered to operate some function of the chore product to facilitate performing a chore. In some embodiments, a chore is a task performed, either by a user or autonomously, at or near a household, a farm, an agricultural facility, a building, a sidewalk, a park, a parking lot, a forest, a field, and/or a lawn. In some embodiments, a chore product transports an operator and performs a chore. In some embodiments, a chore product autonomously operates to perform a chore without an operator being present on the chore product or physically/manually manipulating the chore product.

### Chore Product

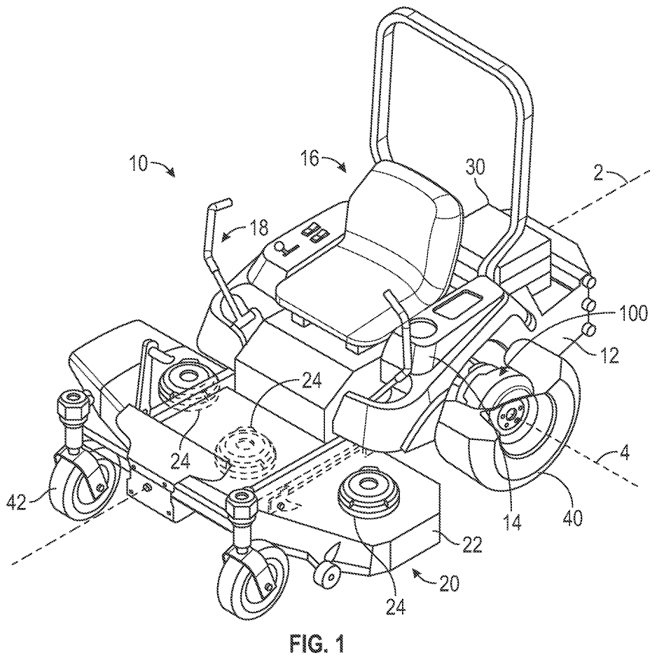

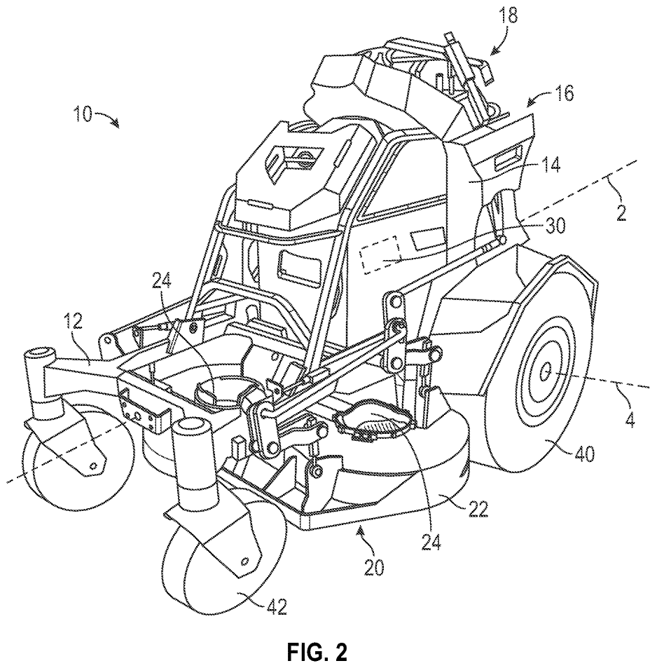

According to the exemplary embodiment shown in FIGS. 1-3, a chore product (e.g., a piece of equipment, a machine, a vehicle, outdoor power equipment, indoor power equipment, a lawn care vehicle or device, a lawn mower, etc.), shown as chore product 10, is configured as an electrified chore product. In some embodiments, the chore product 10 is an all-electric chore product (i.e., does not include an internal combustion engine). According to the exemplary embodiment shown in FIG. 1, the chore product 10 is configured as a zero turn radius (“ZTR”) mower. According to the exemplary embodiment shown in FIG. 2, the chore product 10 is configured as a stand-on mower. In some embodiments, the chore product 10 is configured as a ride-on or riding mower (i.e., a non-ZTR ride-on or riding mower). In some embodiments, the chore product 10 is configured as a walk-behind mower.

While the chore product 10 is shown to be configured as a mower, it is contemplated that the chore product 10 may be configured as or the features thereof may be implemented on other electrified chore products or “light” electrified vehicles, machines, or equipment, including outdoor power equipment, indoor power equipment, light vehicles, floor care devices, golf carts, lift trucks and other industrial vehicles, pavement surface preparation devices, recreational utility vehicles, industrial utility vehicles, lawn and garden equipment, and/or still other suitable vehicles, machines, or equipment. Outdoor power equipment may include lawn mowers, riding tractors, snow throwers, pressure washers, tillers, log splitters, walk-behind mowers, riding mowers, and turf equipment such as sod cutters, aerators, spreaders, sprayers, seeders, power rakes, and blowers. Outdoor power equipment may, for example, use one or more electric motors to drive an implement, such as a rotary blade of a lawn mower, a pump of a pressure washer, the auger of a snow thrower, the alternator of a generator, and/or a drivetrain of the outdoor power equipment. Indoor power equipment may include floor sanders, floor buffers and polishers, vacuums, etc. Recreational utility vehicles may include all-terrain vehicles (“ATVs”), utility task vehicles (“UTVs”), etc. Industrial utility vehicles may include forklifts, aircraft tugs, aerial lifts such as scissor lifts and boom lifts, etc.

As shown in FIGS. 1-3, the chore product 10 includes a chassis, shown as frame assembly 12; a chassis cover, shown as chore product body 14, positioned over and extending along a least a portion of the frame assembly 12 (e.g., a rear half thereof, a rear and/or center portion thereof, etc.); an operator area, shown as operator area 16, including various operator interfaces, shown as operator controls 18; an implement assembly, shown as mower deck 20, coupled to the frame assembly 12 and positioned in front of the chore product body 14 and the operator area 16; an energy storage device (e.g., a battery bank, a battery array, etc.), shown as battery module 30, coupled to or otherwise supported by the frame assembly 12; various tractive elements including first tractive elements, shown as rear wheels 40, and second tractive elements, shown as front wheels 42; an electrical distribution system, shown as electrical bus 50; and a powertrain or drivetrain, shown as driveline 100, coupled to and supported by the frame assembly 12. In some embodiments, the rear wheels 40 and/or the front wheels 42 are replaced with track elements. As shown in FIGS. 1 and 2, (a) the frame assembly 12 defines a first axis, shown as longitudinal axis 2, that is centrally aligned and extends longitudinally from the front end to the rear end of the chore product 10 and (b) the driveline 100 (e.g., half-shaft axles 140) defines a second axis, shown as lateral axis 4, that extends laterally across the chore product 10 through the centers of the rear wheels 40.

According to the exemplary embodiment shown in FIG. 1, the operator area 16 is a seating area that includes a seat for the operator to sit while driving or otherwise controlling operations of the chore product 10. According to the exemplary embodiment shown in FIG. 2, the operator area 16 is a stand-on area that includes a platform for the operator to stand on while driving or otherwise controlling operations of the chore product 10. In some embodiments, the operator area 16 is or includes handles or a handle bar that the operator walks behind. The operator controls 18 may include various input and/or output devices to facilitate operator control of the chore product 10 (e.g., joysticks, a steering wheel, a gear selector, a throttle or accelerator pedal, a brake lever or brake pedal, switches, knobs, displays, gauges, etc.).

As shown in FIGS. 1-3, the mower deck 20 includes a housing, shown as shroud 22; one or more implement motors, shown as implement motors 24, coupled to the shroud 22; and a plurality of implements, show as cutting blades 26, coupled to and driven by the implement motors 24. While the mower deck 20 is shown as being positioned proximate the front of the chore product 10, in other embodiments, the mower deck 20 is positioned beneath the operator area 16 (e.g., on a ride-on or riding mower) or is trailed behind and pulled by the chore product 10. In other embodiments, the mower deck 20 is replaced or supplemented with a variety of other types of implements based on the intended end use of the chore product 10 (e.g., an auger assembly for a snow blower, an aerator mechanism for an aerator, etc.). In such non-mower implementations, the implement motors 24 may drive other types of implements than the cutting blades 26 (e.g., blowers, spreaders, power rakes, polishers, augers, aerators, etc.).

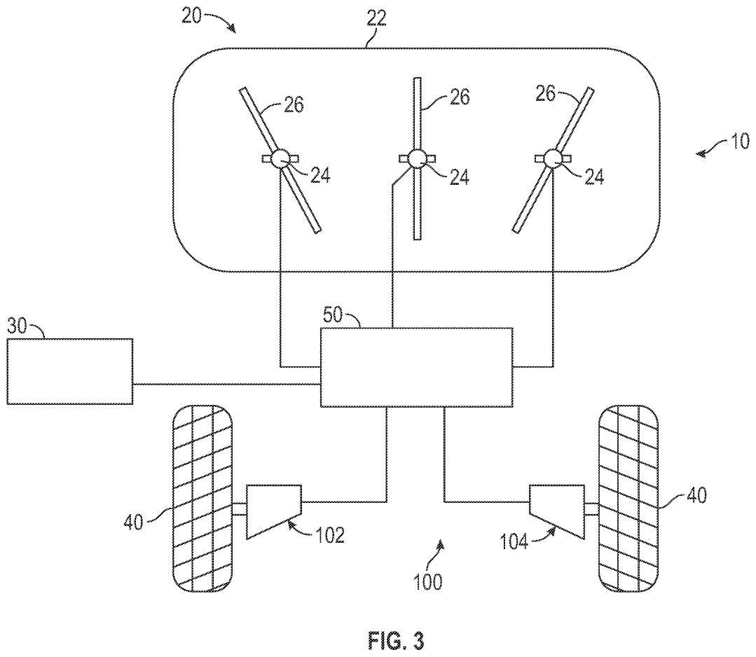

As shown in FIG. 1, the battery module 30 is positioned rearward of the operator area 16 and the chore product body 14. As shown in FIG. 2, the battery module 30 is positioned underneath the chore product body 14. In other embodiments, the battery module 30 is otherwise positioned (e.g., above the mower deck 20, trailed, etc.). As shown in FIG. 3, the battery module 30 is electrically coupled to and configured to power various electrical components or systems of the chore product 10 (e.g., the driveline 100, the implement motors 24, the operator controls 18, lights, displays, etc.) via the electrical bus 50. The battery module 30 may include a plurality of battery packs and/or cells. In some embodiments, the battery module 30 is removable. In some embodiments, the battery module 30 is rechargeable. The battery module 30 may include battery cells having one or more battery chemistries including, but not limited to, lithium ion, lithium iron phosphate, lithium polymer, nickel cadmium, lead-acid, nickel-metal hydride, and/or the like. The battery module 30 may be interchangeable between different chore products (e.g., between the chore product 10, a mower, a snow blower, a UTV, an ATV, a golf cart, an aerator, etc.). In some embodiments, the battery module 30 is removable without the use of tools.

For example, the battery module 30 may be removably coupled to the chore product 10 by one or more latches, straps, detents, magnets, electrical coupler, slots, compartments, etc., or any combination thereof.

### Driveline

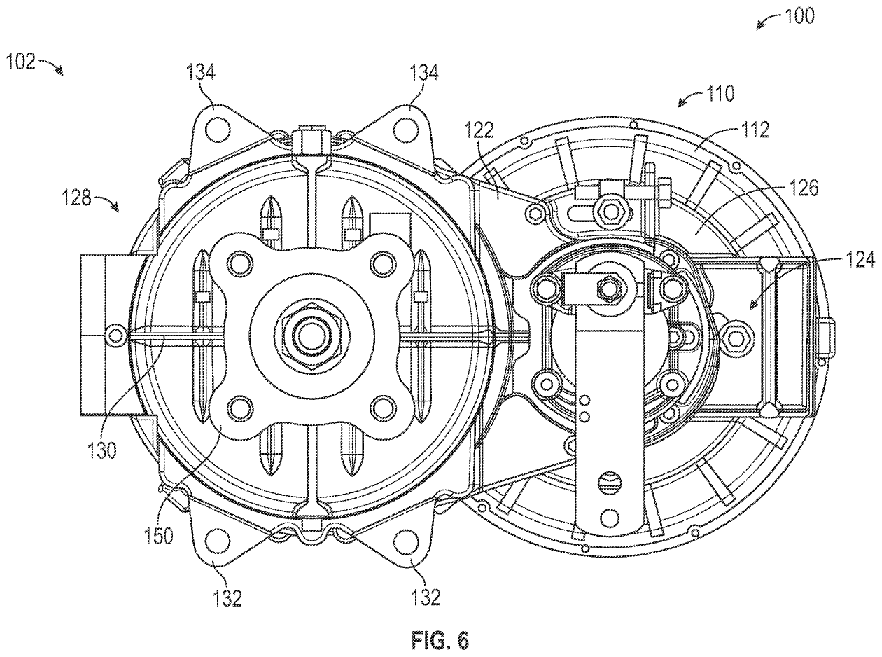

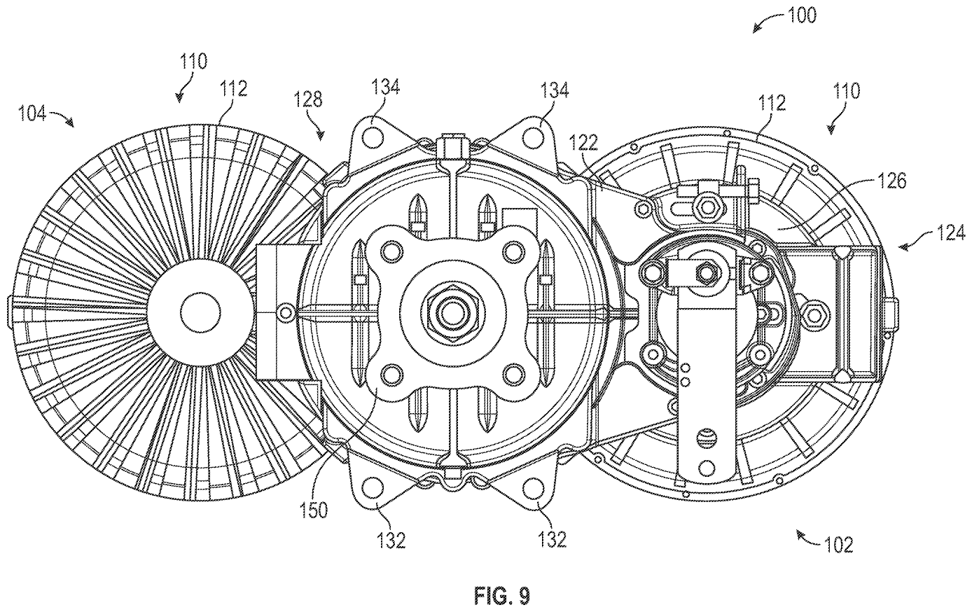

As shown in FIGS. 3-9, the driveline 100 includes (a) a first drive assembly, shown as left drive assembly 102, coupled to a first or left, rear wheel 40 positioned on the left side of the chore product 10 and (b) a second drive assembly, shown as right drive assembly 104, coupled to a second or right, rear wheel 40 positioned on the right side of the chore product 10. According to an exemplary embodiment, the components of the left drive assembly 102 and the right drive assembly 104 are substantially the same, except for the specific configuration or orientation thereof (e.g., mirrored/flipped about the longitudinal axis 2 and/or mirrored/flipped about the lateral axis 4, a symmetric orientation, a nested orientation, etc.).

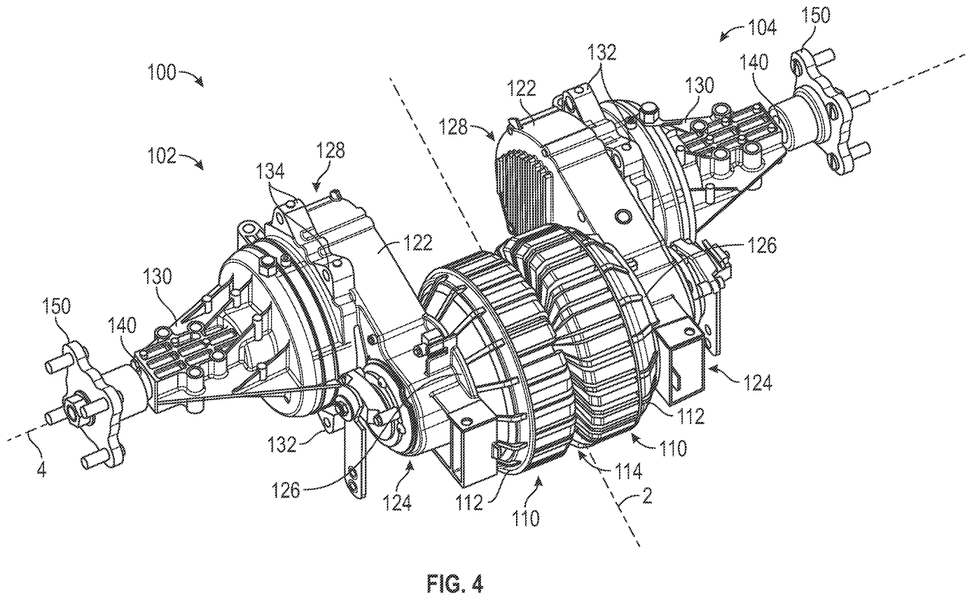

As shown in FIGS. 4-9, each of the left drive assembly 102 and the right drive assembly 104 includes a tractive motor, shown as drive motor 110, a transmission device, shown as axle transmission 120, an axle, shown as half-shaft axle 140, and a hub, shown as wheel hub 150. The drive motor 110 includes a housing, shown as motor housing 112.

According to an exemplary embodiment, the drive motor 110 is electrically coupled to and powered by the battery module 30 via the electrical bus 50.

As shown in FIGS. 4-9, the axle transmission 120 includes a main housing, shown as transmission housing 122, having a first end, shown as motor end 124, and an opposing second end, shown as axle end 128. The motor end 124 of the transmission housing 122 defines a first interface, shown as motor flange 126, that engages with the motor housing 112 to facilitate coupling the motor housing 112 to the transmission housing 122. The axle end 128 of the transmission housing 122 defines a second interface, shown as axle body 130, that receives the half-shaft axle 140, to facilitate coupling the half-shaft axle 140 to the axle transmission 120. The wheel hub 150 is coupled to the free end of the half-shaft axle 140 and is configured to facilitate coupling a respective one of the rear wheels 40 to the half-shaft axle 140 and the remainder of the left drive assembly 102 or the right drive assembly 104.

According to the exemplary embodiment shown in FIGS. 4-9, the axle transmission 120 is structured such that the drive motor 110 is offset from the half-shaft axle 140. More specifically, an axis along which an output of the drive motor 110 extends is parallel to and offset from the lateral axis 4 along which the half-shaft axle 140 extends. According to an exemplary embodiment, the axle transmission 120 includes various internal components (e.g., input transmission components, output transmission components, connecting transmission components, gears, pulleys, sheaves, belts, chains, etc.) that facilitate coupling the drive motor 110 to the half-shaft axle 140 so that the drive motor 110 can drive the half-shaft axle 140 and, therefore, a respective one of the rear wheels 40. More specifically, the output of the drive motor 110 interfaces with the input transmission components of the axle transmission 120 disposed within the motor end 124 of the transmission housing 122 and an input of the half-shaft axle 140 interfaces with the output transmission components of the axle transmission 120 disposed within the axle end 128 of the transmission housing 122 where the input transmission components are coupled to the output transmission components.

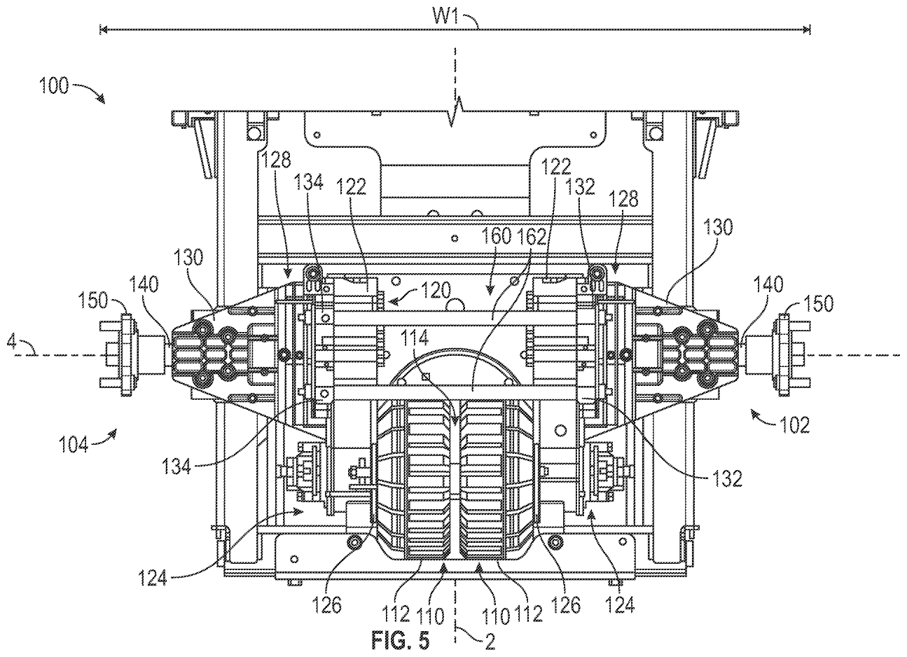

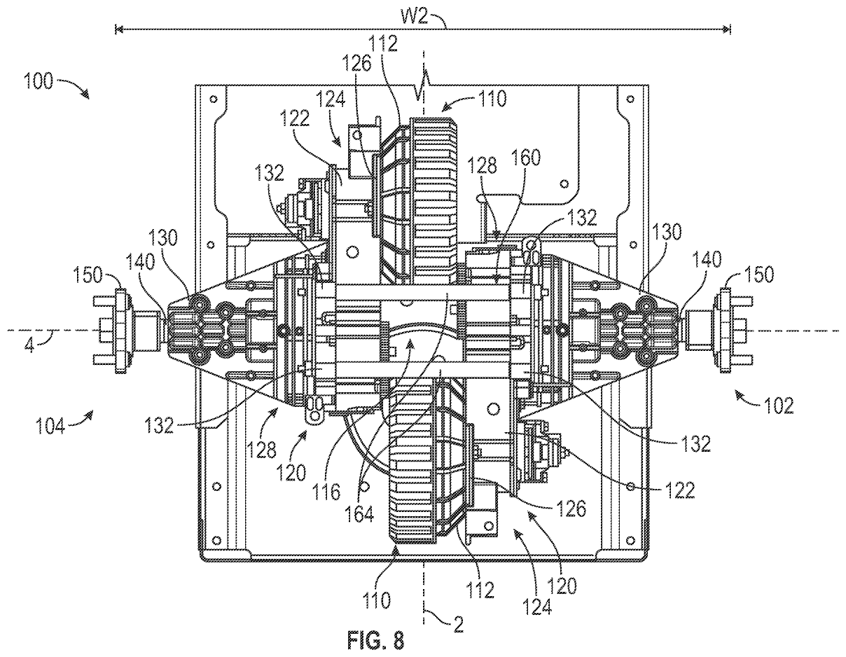

As shown in FIGS. 5 and 8, the axle body 130 is coupled to a first lateral side or an opposing second lateral side of the frame assembly 12 (e.g., via fasteners, bolts, etc.) and, thereby, the axle body 130 couples the remainder of the components of the left drive assembly 102 or the right drive assembly 104 and a respective one of the rear wheels 40 to the frame assembly 12. As shown in FIGS. 4-9, the transmission housing 122 defines or includes one or more (e.g., one, two, three, etc.) third interfaces (e.g., flanges, brackets, ears, mounts, tabs, protrusions, extensions, hubs, connection interfaces, etc.), shown as connection hubs 132, and one or more fourth interfaces, shown as connection hubs 134, positioned proximate the axle end 128. The connection hubs 132 extend outward from the transmission housing 122 in a first direction (e.g., upward) and the connection hubs 134 extend outward from the transmission housing 122 in a second direction generally opposite the first direction (e.g., downward). Stated another way, the connection hubs 132 and the connection hubs 134 are positioned at opposing sides of the transmission housing 122 or mirrored about the longitudinal axis 2.

As shown in FIGS. 4-6, the left drive assembly 102 and the right drive assembly 104 are mountable to the frame assembly 12 in a first or symmetric orientation where the left drive assembly 102 and the right drive assembly 104 are symmetrically coupled to the frame assembly 12 about the longitudinal axis 2 such that (a) the connection hubs 132 of the transmission housing 122 of the left drive assembly 102 align with the connection hubs 134 of the transmission housing 122 of the right drive assembly 104 and (b) the connection hubs 134 of the transmission housing 122 of the left drive assembly 102 align with the connection hubs 132 of the transmission housing 122 of the right drive assembly 104. Accordingly, the left drive assembly 102 is mirrored or flipped about the longitudinal axis 2 relative to the right drive assembly 104 such that the drive motors 110 (a) are in alignment with a first gap, shown as lateral motor spacing 114, positioned therebetween and (b) are positioned at least partially rearward of the lateral axis 4 (e.g., partially, completely, etc.). In other embodiments, the drive motors 110 are positioned at least partially forward of the lateral axis 4 (e.g., partially, completely, etc.). As shown in FIG. 5, a connection or linking assembly, shown as cross-brace 160, includes one or more first connectors or linking bars (e.g., corresponding to the number of connection hubs 132 and the connection hubs 134), shown as first crossbars 162, that extend between the connection hubs 134 of the right drive assembly 104 and the connection hubs 132 of the left drive assembly 102 to couple the left drive assembly 102 and the right drive assembly 104 together. According to an exemplary embodiment, the cross-brace 160 provides enhanced or increased rigidity to the driveline 100 to handle external loading (e.g., as the chore product 10 is moved, driven, etc.) and/or internal loading (e.g., torsional loading from the drive motors 110, the axles transmissions 120, the half-shaft axles 140, etc.). In some embodiments, the first crossbars 162 additionally or alternatively extend between the connection hubs 132 of the right drive assembly 104 and the connection hubs 134 of the left drive assembly 102 (e.g., in embodiments where upper and lower first crossbars 162 are both used, in embodiments where the left drive assembly 102 and the right drive assembly 104 are rotated 180 degrees about the lateral axis 4, etc.).

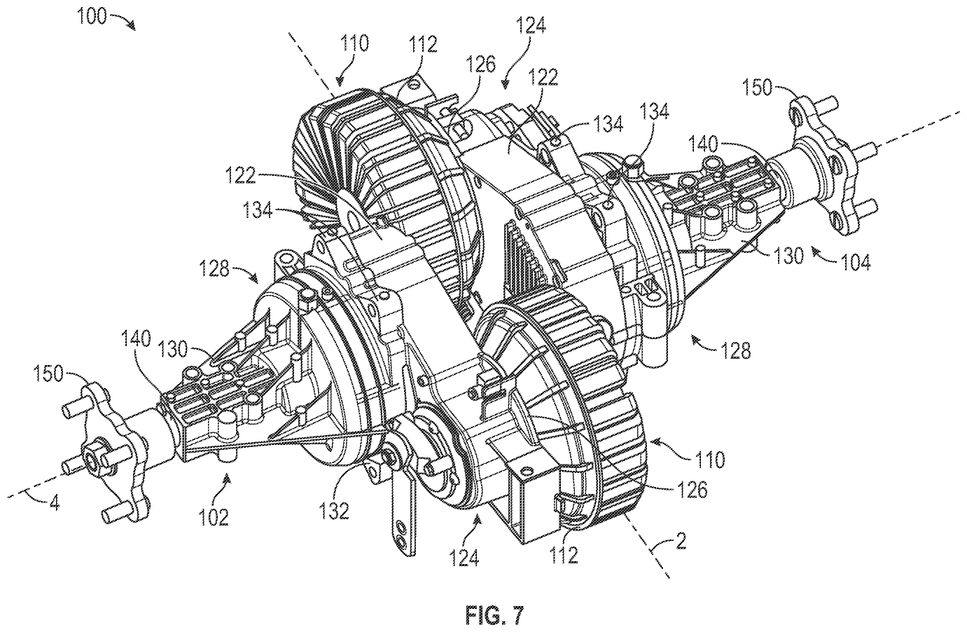

As shown in FIGS. 7-9, the left drive assembly 102 and the right drive assembly 104 are mountable to the frame assembly 12 in a second or nested orientation where the left drive assembly 102 and the right drive assembly 104 are coupled to the frame assembly 12 such that the drive motors 110 are nested and (a) the connection hubs 132 of the transmission housing 122 of the right drive assembly 104 align with the connection hubs 132 of the transmission housing 122 of the left drive assembly 102 and (b) the connection hubs 134 of the transmission housing 122 of the right drive assembly 104 align with the connection hubs 134 of the transmission housing 122 of the left drive assembly 102. Accordingly, the left drive assembly 102 is (a) mirrored or flipped about the longitudinal axis 2 relative to the right drive assembly 104 and (b) mirrored or flipped about the lateral axis 4 relative to the right drive assembly 104 such that the drive motors 110 (i) at least partially laterally overlap and/or (ii) are longitudinally offset along longitudinal axis 2 with a second gap, shown as longitudinal motor spacing 116, positioned therebetween with a first one of the drive motors 110 positioned at least partially forward of the lateral axis 4 (e.g., partially, completely, etc.) and a second one of the drive motors 110 positioned at least partially rearward of the lateral axis 4 (e.g., partially, completely, etc.). As shown in FIG. 8, the cross-brace 160 includes one or more second connectors or linking bars (e.g., corresponding to the number of connection hubs 132), shown as second crossbars 164, that extend between the connection hubs 132 of the right drive assembly 104 and the connection hubs 132 of the left drive assembly 102 to couple the left drive assembly 102 and the right drive assembly 104 together. In some embodiments, the second crossbars 164 additionally or alternatively extend between the connection hubs 134 of the right drive assembly 104 and the connection hubs 134 of the left drive assembly 102 (e.g., in embodiments where upper and lower second crossbars 164 are both used, in embodiments where the left drive assembly 102 and the right drive assembly 104 are rotated 180 degrees about the lateral axis 4, etc.). In some embodiments, the second crossbars 164 have a different, shorter length than the first crossbars 162.

As shown in FIG. 5, the symmetric orientation of the left drive assembly 102 and the right drive assembly 104 provides the driveline 100 having a first wheel track W₁ extending between the wheel hubs 150 and having a first width. As shown in FIG. 7, the nested orientation of the left drive assembly 102 and the right drive assembly 104 provides the driveline 100 having a second wheel track W₂ extending between the wheel hubs 150 and having a second width. According to an exemplary embodiment, the nested orientation facilitates removing the lateral motor spacing 114 between the drive motors 110 and “over-retracting” the drive motors 110 such that the drive motors 110 are nested and at least partially overlap in a lateral direction along the lateral axis 4. Accordingly, the second wheel track W₂ can be less than the first wheel track W₁. The nested orientation, therefore, facilitates packaging the driveline 100 on the chore product 10 when the chore product 10 requires a narrower wheel track than the symmetric orientation of the driveline 100 can provide without requiring the replacement of the drive motors 110, the axle transmissions 120, or the half-shaft axles 140, while still permitting either orientation when the chore product 10 permits or requires a wider wheel track (i.e., only different cross-braces 160 may be required). In some embodiments, the axle transmissions 120 are extended or elongated in the longitudinal direction such that drive motors 110 can be over-retracted at least partially past the axle transmissions 120 when in the nested orientation to permit an even more compact or narrow wheel track.

According to the exemplary embodiment shown in FIG. 5, the first width of the first wheel track W₁ is about 33.7 inches (about 856 millimeters) to accommodate a wheel track for a “small class” ZTR mower. According to the exemplary embodiment of FIG. 8, the second width of the second wheel track W₂ is about 29.8 inches (about 758 millimeters) to accommodate a wheel track for a “compact class” ZTR or stand-on mower. The wheel track dimensions outlined herein should be understood as providing just two possible wheel track examples and should not be considered limiting. Further, the width of the second wheel track W₂ can be increased to be the same or even greater than the first wheel track W₁ by employing a wider cross-brace 160.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the chore product 10 and the driveline 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein. This listing of claims will replace all prior versions and listings of claims in the Application. Listing of Claims:

1. An electrified chore product comprising:
a chassis;
an energy storage device supported by the chassis;
a left tractive element;
a right tractive element;
a left drive assembly coupled to the chassis; and
a right drive assembly coupled to the chassis;
wherein each of the left drive assembly and the right drive assembly includes:
a drive motor coupled to the energy storage device;
an axle coupled to a respective one of the left tractive element or the right tractive element; and
a transmission positioned between the drive motor and the axle, the transmission including a housing having a first end and a second end, the housing defining:
a first interface positioned at the first end, the first interface engaging with the drive motor;
a second interface positioned at the second end, the second interface receiving the axle;
a third interface positioned proximate the second end, the third interface extending from the housing in a first direction; and
a fourth interface positioned proximate the second end, the fourth interface extending from the housing in a second direction generally opposite the first direction; and
wherein the left drive assembly and the right drive assembly are mountable to the chassis in either (a) a first orientation where the third interface of the left drive assembly and the fourth interface of the right drive assembly align or (b) a second orientation where the third interface of the left drive assembly and the third interface of the right drive assembly align.

2. The electrified chore product of claim 1, wherein the left drive assembly and the right drive assembly are mounted to the chassis in the first orientation.

3. The electrified chore product of claim 2, wherein the electrified chore product is a zero radius turn mower.

4. The electrified chore product of claim 1, wherein the left drive assembly and the right drive assembly are mounted to the chassis in the second orientation.

5. The electrified chore product of claim 2, wherein the electrified chore product is a ride-on mower.

6. The electrified chore product of claim 1, wherein the chassis defines a longitudinal axis, and wherein, when in the first orientation, the drive motor of the left drive assembly and the drive motor of the right drive assembly are longitudinally aligned along the longitudinal axis and laterally offset such that a lateral gap is present therebetween where the drive motor of the left drive assembly and the drive motor of the right drive assembly are at least partially positioned forward of or at least partially positioned rearward of a lateral axis defined by the axle of the left drive assembly and the axle of the right drive assembly.

7. The electrified chore product of claim 1, wherein the chassis defines a longitudinal axis, and wherein, when in the second orientation, the drive motor of the left drive assembly and the drive motor of the right drive assembly are at least partially laterally overlapping and longitudinally offset along the longitudinal axis such that a longitudinal gap is present therebetween where (a) the drive motor of one of the left drive assembly or the right drive assembly is at least partially positioned forward of a lateral axis defined by the axle of the left drive assembly and the axle of the right drive assembly and (b) the drive motor of the other of the left drive assembly or the right drive assembly is at least partially positioned rearward of the lateral axis.

8. The electrified chore product of claim 7, wherein the drive motor of the left drive assembly at least partially laterally overlaps the transmission of the right drive assembly, and wherein the drive motor of the right drive assembly at least partially laterally overlaps the transmission of the left drive assembly.

9. The electrified chore product of claim 1, wherein the first end of the housing of the transmission is longitudinally offset from the second end of the housing of the transmission.

10. The electrified chore product of claim 1, wherein the third interface includes a first pair of connection hubs, and wherein the fourth interface includes a second pair of connection hubs.

11. The electrified chore product of claim 1, wherein the third interface extends vertically upward, and wherein the fourth interface extends vertically downward.

12. The electrified chore product of claim 1, further comprising a cross-brace extending between either (a) the third interface of the left drive assembly and the fourth interface of the right drive assembly or (b) the third interface of the left drive assembly and the third interface of the right drive assembly.

13. The electrified chore product of claim 12, wherein a length of the cross-brace varies depending on whether the cross-brace is extending between (a) the third interface of the left drive assembly and the fourth interface of the right drive assembly or (b) the third interface of the left drive assembly and the third interface of the right drive assembly.

14. A driveline for electrified chore products, the driveline comprising:
a first drive assembly;
a second drive assembly; and
a cross-brace extending between the first drive assembly and the second drive assembly;
wherein each of the first drive assembly and the second drive assembly includes:
a drive motor;
an axle configured to couple to a tractive element; and
a transmission including a housing having (a) a first end coupled to the drive motor and (b) a second end longitudinally offset from the first end and coupled to the axle; and
wherein the first drive assembly and the second drive assembly are mountable to frames of the electrified chore products in different orientations to provide varying width wheel tracks.

15. The driveline of claim 14, wherein the different orientations include:
a first orientation where the drive motor of the first drive assembly and the drive motor of the second drive assembly are longitudinally aligned; and
a second orientation where the drive motor of the first drive assembly and the drive motor of the second drive assembly are at least partially laterally overlapping.

16. The driveline of claim 15, wherein, in the first orientation, the drive motor of the first drive assembly and the drive motor of the second drive assembly are at least partially positioned forward of or at least partially positioned rearward of a lateral axis defined by the axle of the first drive assembly and the axle of the second drive assembly.

17. The driveline of claim 16, wherein, in the second orientation, (a) the drive motor of one of the first drive assembly or the second drive assembly is at least partially positioned forward of the lateral axis defined and (b) the drive motor of the other of the first drive assembly or the second drive assembly is at least partially positioned rearward of the lateral axis.

18. A driveline for an electrified chore product, the driveline comprising:
a first drive assembly configured to couple to a first lateral side of a chassis of the electrified chore product; and
a second drive assembly configured to couple a second lateral side of the chassis;
wherein each of the first drive assembly and the second drive assembly includes:
a drive motor;
an axle configured to couple to a tractive element; and
a transmission including a housing having (a) a first end coupled to the drive motor and (b) a second end longitudinally offset from the first end and coupled to the axle; and
wherein the first drive assembly and the second drive assembly are configured to be arranged in a plurality of orientations including:
a first orientation where the drive motor of the first drive assembly and the drive motor of the second drive assembly are longitudinally aligned along a longitudinal axis of the chassis; and
a second orientation where the drive motor of the first drive assembly and the drive motor of the second drive assembly are at least partially laterally overlapping.

19. The driveline of claim 18, wherein the first orientation provides a first wheel track having a first width and the second orientation provides a second wheel track having a second width that is less than the first width.

20. The driveline of claim 18, wherein, in the first orientation, the drive motor of the first drive assembly and the drive motor of the second drive assembly are at least partially laterally offset such that a lateral gap is present therebetween, and wherein, in the second orientation, the drive motor of the first drive assembly and the drive motor of the second drive assembly are longitudinally offset along the longitudinal axis such that a longitudinal gap is present therebetween.

21-25. (canceled)
